(19) United States
(12) Patent Application Publication
(10) Pub. No.: US 2021/0403374 A1
(43) Pub. Date: Dec. 30, 2021

(54) METHOD OF MANUFACTURING OPAQUE QUARTZ GLASS

(71) Applicant: Tosoh Quartz Corporation, Yamagata-shi, Yamagata (JP)

(72) Inventors: Chiemi ITO, Yamagata-shi, Yamagata (JP); Takeshi MUTOU, Yamagata-shi, Yamagata (JP); Masahiro SATO, Yamagata-shi, Yamagata (JP); Takaya SUZUKI, Yamagata-shi, Yamagata (JP); Minoru KUNIYOSHI, Yamagata-shi, Yamagata (JP)

(21) Appl. No.: 17/292,602

(22) PCT Filed: Dec. 14, 2018
(86) PCT No.: PCT/JP2018/046059

§ 371 Date: May 10, 2021

(51) Int. Cl. C03C 11/00; C03C 3/06; C03C 1/02; C03B 20/00

(52) U.S. Cl. CPC C03C 11/00; C03C 3/06; C03C 1/026; C03C 2203/10; C03C 2204/04; C03C 2201/80; C03B 20/00

(57) ABSTRACT

A method for manufacturing a large sized opaque quartz glass ingot having excellent heat ray shielding and light blocking properties without using a foaming agent. The obtained opaque quartz glass has small diameter spherical bubbles and a preferable mechanical strength. Silica powder is dispersed in water to form a slurry having a silica powder concentration of 45 to 75 wt % and the average particle size of the silica powder is adjusted to 8 μm or less and the standard deviation of the particle size is adjusted to 6 μm or more by wet pulverization. The slurry is sprayed for forming granules of the silica powder. An opaque quartz glass ingot with a small bubble diameter and high mechanical strength is obtained by melting the granulated silica powder.

### TECHNICAL FIELD

The present invention relates to a method for manufacturing opaque quartz glass having excellent heat insulating property and light blocking property. More specifically, the present invention relates to a method for manufacturing an opaque quartz glass ingot suitably applicable to a member of a semiconductor manufacturing apparatus, a component for an optical instrument or the like.

### BACKGROUND TECHNOLOGY

Quartz glass is used for various purposes such as lighting equipment, optical equipment parts, semiconductor industrial parts, and physical and chemical experimental equipment because of its excellent transparency, high heat resistance, and chemical resistance. Among them, opaque quartz glass containing bubbles in quartz glass has been used for flanges and core tubes of semiconductor heat treatment equipment because of its excellent heat ray blocking property. Further, since it has excellent light-shielding properties, it is also used as an optical device component such as a reflector base material of a light source lamp or a projector.

Conventional method of producing opaque quartz glass is as follows.

According to the well-known method, first, adding a foaming agent such as silicon nitride to crystalline silica or amorphous silica by dry mixing and melting the mixture by hydrogen-oxygen flame (for example, Patent Document 1). According to this manufacturing method, a large ingot can be easily obtained. However, this method and the obtained opaque quartz glass according to this method have the following defects.

(1) As the foaming agent is lost during the melting process, it is necessary to add extra amount of the foaming agent in order to obtain desired opacity, and it costs much.
(2) And the foaming agents do not disperse uniformly and the aggregated foaming agents tend to produce rather larger diameter bubbles, and the mechanical strength and light reflectance of the obtained opaque quartz glass decrease.
(3) Since the size of the air bubbles are rather large, the baked surface of the opaque quartz glass ingot is rough, and when the obtained opaque quartz glass is used as a flange, contact faces between the flanges are not completely flat, a leakage occurs between the contact faces of the flanges. Further, when used as a reflector base material of a projector, light from the lamp may scatter or leak from the apparatus, which may adversely affect the electronic components installed inside the projector.

On the other hand, in Document 2 (JP patent No. 3394323) and Patent Document 3 (JP patent No. 3763420), in which a method disclosed is to heat a molded body of amorphous silica powder at a temperature equal to or lower than its melting temperature without adding a foaming agent and interrupting heat treatment before it is completely densified, and partially sinter it. It is proposed, although the opaque quartz glass produced according to these production methods can reduce the average diameter of the bubbles, when the cells are sintered until they are closed, the content density of the bubbles becomes small and infrared rays are reflected. There is a problem that the rate is lowered, and as the obtained bubbles are not spherical in shape, stress is concentrated to the edges of the bubbles, and there is a problem that the mechanical strength of the opaque quartz glass becomes low. In addition, the size of the molded body is limited, and it is difficult to produce a large sized opaque quartz glass ingot.

### PRIOR ART DOCUMENT

### Patent Document

[Patent Document 1] JP No. 3043032
[Patent Document 2] JP No. 3394323
[Patent Document 3] JP No. 3763420 (Heraeus Quartzglas Gmbh)

### DISCLOSURE OF INVENTION

### Problems to be Solved

The present invention solves the above-mentioned problems, and enables the production of opaque quartz glass without using a foaming agent which has been considered to be indispensable for the production method of the prior arts and provides a method of manufacturing the opaque quarts glass having excellent in heat ray blocking property and light blocking property required for opaque quartz glass.

An objective of the present invention is to make it possible to easily manufacture a large sized opaque quartz glass ingot having small diameter bubbles of spherical in shape and excellent mechanical strength.

### Means for Solving Problems

Granulated silica powder obtained by silica powder spray-drying and granulating slurry in which silica powder is dispersed in water with an average particle size of the crushed powder of 8 μm or less and a standard deviation of the particle size of the crushed powder of 6 μm or more is heated by wet pulverization. Melting an opaque quartz glass ingot having spherical bubbles in shape and a small bubble diameter is manufactured.

Hereinafter, each step of manufacturing process will be described in detail. In addition, it is necessary to provide clean equipment, so that impurity contamination will be avoided in all processes.

### (1) Preparation of Raw Material Silica Powder

The production method of the silica powder is not particularly limited, and for example, an amorphous silica powder produced by hydrolyzing silicon alkoxide, a silica powder produced by hydrolyzing silicon tetrachloride with an acid hydrogen flame or the like is used. In addition, powder of crushed natural quartz or fumed silica can also be used.

The average particle size of the silica powder is preferably 300 μm or less. If the average particle size exceeds 300 μm and is too large, it takes a long time for wet pulverization of the silica powder, which is not preferable and it lower productivity of the products and increases production cost.

The average particle size of the silica powder is measured using a laser diffraction particle size distribution measuring device (Mastersizer 3000 manufactured by Malvern).

### (2) Slurry Adjustment

The concentration of the slurry in which the silica powder is dispersed in water is preferably 45 to 75 wt %, preferably 60 to 70 wt %. If it exceeds 75 wt %, the viscosity of the slurry becomes high and wet pulverization cannot be performed. A concentration of less than 45 wt % is not desirable because the slurry has a large amount of water and it requires a large amount of heat for drying, which results in a decrease in productivity and an increase in production cost.

### (3) Wet Pulverization of Slurry

The concentration-adjusted slurry is wet-ground using one or more beads selected from quartz glass beads, zirconia beads, silicon carbide beads, and alumina beads having an average particle size of 0.1 mm to 10 mm. It is essential that the average particle size of the pulverized powder contained in the slurry is 8 μm or less and the standard deviation of the particle size of the pulverized powder is 6 μm or more. If the average particle size of the pulverized powder is larger than 8 μm, the whiteness decreases. If the standard deviation of the particle size of the crushed powder is less than 6 μm, the whiteness will decrease.

The average particle size and standard deviation of the pulverized powder were measured using a laser diffraction particle size distribution measuring device (Mastersizer 3000 manufactured by Malvern).

The BET specific surface area of the pulverized powder contained in the slurry after wet pulverization is preferably 2 m2/g or more. More preferably, wet pulverization is performed until it reaches 4 m2/g or more, preferably 6 m2/g or more.

When the BET specific surface area is smaller than 2 m2/g, the strength of the granulated powder is lowered, the granulation is broken, and the yield at the time of melting the oxyhydrogen flame is lowered.

The method of wet pulverization of the slurry is not particularly limited, and examples thereof include bead mill pulverization, ball mill pulverization, vibration mill pulverization, and at lighter pulverization. In particular, it is preferable to use bead mill pulverization or a combination of ball mill pulverization and bead mill pulverization to obtain preferable results.

### (4) Spray Drying Granulation

Next, the slurry prepared by the above method is spray-dried to obtain granulated silica powder. The obtained granulated powder is substantially spherical, having an average particle size of 30 to 200 μm, and water content of 3 wt % or less.

If the average particle size is less than 30 μm, the granulated silica powder dissipates during the melting process by oxy-hydrogen flame, and a productivity of the melting process becomes low.

If the average particle size exceeds 200 μm, the granules collapse into small pieces and blown away by the flame during the melting process and results in poor yield. If the water content exceeds 3 wt %, the fluidity of the granulated powder becomes low and the supply amount of the granulated powder per unit time during the melting process, the oxyhydrogen flame decreases, so that the productivity becomes low.

The average particle size of the granulated powder is measured using a laser diffraction particle size distribution measuring device (master sizer 3000) manufactured by Malvern Co., Ltd., same as measuring the diameter of the pulverized powder.

### (5) Melting of Granulated Powder

Next, the opaque quartz glass is obtained by melting the obtained granulated powder with an oxy-hydrogen flame under vacuum atmosphere.

Opaque quartz glass products are obtained by machining the obtained opaque quartz glass ingot through the above steps using machines such as a band saw, a wire saw, or a core drill commonly used in manufacturing quartz glass members.

### (6) Purity of the Opaque Quartz Glass

The purity of the opaque quartz obtained according to the invention can be controlled by purity of silica powder selected as the raw material. Except for the constituent elements of the beads used as the crushing medium, the purity of the final product is almost the same as that of the raw material of the silica powder.

### Advantages of the Invention

In the method for manufacturing opaque quartz glass of the present invention, the average particle size is 8 μm or less and the standard deviation of the particle size is 6 μm by wet pulverizing slurry in which the raw material silica powder is dispersed in water at a predetermined concentration without using a foaming agent. The granulated powder prepared as described above, dried and granulated is used as a molten raw material, and consequently opaque quartz glass can be easily obtained compared with the prior arts of manufacturing method of the prior arts.

The opaque quartz glass manufactured by the present invention is excellent in heat ray shielding property and light blocking property, and is particularly used for various core tubes, jigs and containers such as bell jars, which used in the semiconductor manufacturing field, for example, for processing silicon wafers. It is suitable as a constituent material for the core tube, core tube flange, heat insulating fins, and a crucible for melting silicon. It can also be used as a reflector base material for a light source lamp of a projector of optical device components.

### BEST MODE FOR CARRYING OUT THE INVENTION

The present invention is specifically described with reference to following examples, but the present invention is not limited to the examples.

### Example 1

Amorphous silica (D₁₀: 38 μm, D₅₀: 67 μm, D₉₀: 110 μm) is used as the silica raw material powder. Amorphous silica is dispersed in water to form slurry and the concentration of the slurry is adjusted to 67 wt %. Next, the slurry concentration is adjusted using a bead mill crusher with quartz beads having an average particle size of 2.0 mm, the average particle size of the crushed powder is 5 μm and the standard deviation of the particle size of the crushed powder becomes 7.0 μm, under wet pulverization. And consequently the BET specific surface area at this time is 6.0 m²/g.

Next, the pulverized granulation slurry prepared by the above method is spray-dried to obtain granulated powder. The obtained granulated powder has an average particle size of 80 μm and water content of 1 wt %. The obtained granulated powder is melted with an oxyhydrogen flame to produce a column-shaped opaque quartz glass ingot.

The weight of the obtained column-shaped ingot is 500 kg, and the bubbles inside of the opaque quartz glass are observed to be uniformly dispersed according to visual observation, and are aesthetically in good condition.

### Example 2

Amorphous silica (D₁₀: 38 μm, D₅₀: 67 μm, D₉₀: 110 μm) is used as the silica raw material powder. Amorphous silica is dispersed in water to form a slurry, and the concentration of the silica in the slurry is adjusted to 67 wt %. Next, the prepared slurry is put into a beads mill crusher, and using quartz beads having an average particle size of 2.0 mm, the average particle size of the crushed powder is 4 μm and the standard deviation of the particle size of the crushed powder is 6.0 μm.

Wet pulverization is performed and then the BET specific surface area at is 8.0 m²/g. Next, the slurry for pulverization and granulation prepared by the above process is spray-dried to obtain granulated powder. The obtained granulated powder has an average particle size of 80 μm and a water content of 1 wt %. The obtained granulated powder is melted with an oxy-hydrogen flame to produce a column-shaped opaque quartz glass ingot.

The weight of the obtained column-shaped ingot is 500 kg, and the bubbles of the opaque quartz glass ingot are observed to be uniformly dispersed by visual observation, which is also excellent in aesthetics.

### Example 3

Amorphous silica (D₁₀: 38 μm, D₅₀: 67 μm, D₉₀: 110 μm) is used as silica raw material powder. Amorphous silica is dispersed in water to form slurry, and the concentration is adjusted to 67 wt %. Next, the prepared slurry is put into a ball mill crusher, and wet pulverized using silicon carbide beads having an average particle size of 10 mm until the average particle size of the pulverized silica powder becomes 15 μm and the standard deviation of the pulverized powder particle size becomes 14 μm.

The BET specific surface area at this time is 3.0 m²/g. Then the slurry is put into a bead mill crusher, and using quartz beads having an average particle size of 2.0 mm, further wet pulverization is performed so that the average particle size of the crushed powder becomes 6 μm and the standard deviation of the crushed powder particle size is 6.5 μm. The BET specific surface area at this time is 5.5 m²/g. Next, the slurry for pulverization and granulation prepared by the above method is spray-dried to obtain granulated silica powder.

The obtained granulated silica powder has an average particle size of 80 μm and a water content of 1 wt %. The obtained granulated powder is melted by oxyhydrogen flame to manufacture a column-shaped opaque quartz glass ingot.

The weight of the obtained column-shaped ingot is 500 kg, and the bubbles of the opaque quartz glass ingot are observed to be uniformly dispersed by visual observation and the ingot looks good.

### Comparative Example 1

Quartz powder having an average particle size of 150 μm is used as the silica raw material powder. Further, silicon nitride having an average particle size of 2 μm is used as the foaming agent. The mixed concentration of silicon nitride with respect to the silica powder is 0.2 wt %, and the mixed powder is sufficiently mixed and then melted by an acid hydrogen flame to produce a column-shaped opaque quartz glass ingot.

### Comparative Example 2

Amorphous silica (D₁₀: 38 μm, D₅₀: 67 μm, D₉₀: 110 μm) is used as the silica raw material powder. Amorphous silica is dispersed in water to form slurry, and the concentration is adjusted to 40 wt %. Next, the prepared slurry is put into a bead mill crusher, and wet using quartz beads having an average particle size of 2.0 mm so that the average particle size of the crushed powder is 10 μm and the standard deviation of the particle size of the crushed powder is 3 μm. The BET specific surface area at this time is 1.5 m²/g.

Next, the slurry for pulverization and granulation prepared by the above method is spray-dried to obtain granulated powder. The obtained granulated powder has an average particle size of 250 μm and a water content of 4 wt %.

The column-shaped glass ingot obtained by melting the obtained granulated powder with an oxyhydrogen flame is translucent without whitening.

### Comparative Example 3

Amorphous silica (D₁₀: 38 μm, D₅₀: 67 μm, D₉₀: 110 μm) is used as the silica raw material powder. Amorphous silica is dispersed in water to form slurry, and the concentration is adjusted to 40 wt %. Next, the prepared slurry is put into a ball mill crusher, and wet pulverization is performed using quartz beads having an average particle size of 30 mm so that the average particle size of the pulverized powder is 15 μm and the standard deviation of the pulverized powder particle size is 5 μm. The BET specific surface area at this time is 1.8 m²/g. Next, the slurry for pulverization and granulation prepared by the above method is spray-dried to obtain granulated powder. The obtained granulated powder had an average particle size of 20 μm and a water content of 5 wt %. When the obtained granulated powder is melted by an oxyhydrogen flame, the column-shaped glass ingot is translucent without whitening.

### Comparative Example 4

Amorphous silica (D₁₀: 38 μm, D₅₀: 67 μm, D₉₀: 110 μm) is used as the silica raw material powder. The amorphous silica is put into a ball mill crusher and dry crushing is performed using quartz beads having an average particle size of 30 mm and then the average particle size of the crushed powder is 20 μm and the standard deviation of the crushed powder particle size is 5.5 μm. Then the BET specific surface area is 2.0 m²/g. When the obtained pulverized powder is subjected to melting by oxyhydrogen flame, the raw materials are scattered and melting is not accomplished.

Table 1 shows manufacturing conditions of the above described examples and comparative examples, and table 2 shows the average bubble diameter, bubble shape, bubble roundness, density, reflectance, whiteness, and three-point bending strength, and surface roughness of the baked surface obtained opaque quartz glass ingot are shown.

TABLE 1

| | | Mean | Mean | Mean | Standard | BET Specific | Mean | Water | |
|---|---|---|---|---|---|---|---|---|---|
| | | diameter | diameter | diameter | deviation | area of | diameter of | content of | |
| | Slurry | of Ballmill | of Beadsmill | of Crushed | of particle | Crushed | granulated | granulated | |
| | concentration | medium | medium | powder | size of Crushed | powder | powder | powder | Shape |
| | (wt %) | (mm) | (mm) | (μm) | powder (μm) | (m²/g) | (μm) | (wt %) | of Ingot |
| Example 1 | 67 | — | 2.0 | 5 | 7 | 6.0 | 80 | 1 | Column |
| Example 2 | 67 | — | 2.0 | 4 | 6 | 8.0 | 80 | 1 | Column |
| Example 3 | 67 | 10 | 2.0 | 6 | 6.5 | 5.5 | 80 | 1 | Column |
| Comparative | — | — | — | — | — | — | — | — | Column |
| Example1 | | | | | | | | | |
| Comparative | 40 | — | 2.0 | 10 | 3 | 1.5 | 250 | 4 | Column |
| Example 2 | | | | | | | | | |
| Comparative | 40 | 30 | — | 15 | 5 | 1.8 | 20 | 5 | Column |
| Example 3 | | | | | | | | | |
| Comparative | 100 | 30 | — | 20 | 5.5 | 2.0 | — | — | Column |
| Example4 | | | | | | | | | |

TABLE 2

| | Mean | | | | | | Three | | |
|---|---|---|---|---|---|---|---|---|---|
| | diameter of | | | | | | point | Roughness of baked | |
| | Ballmill | | | | | | Bending | surface (μm) | |
| | medium | Bubble | Roundness | Density | Reflectance | Whiteness | strength | Ra | |
| | (μm) | shape | of Bubble | (g/cm³) | (%) | (%) | (MPa) | (μm) | Rmax |
| Example 1 | 25 | Spherical | 0.95 | 2.05 | 86 | 83 | 80 | 0.6 | 0.8 |
| Example 2 | 28 | Spherical | 0.96 | 2.02 | 80 | 80 | 78 | 0.6 | 0.8 |
| Example 3 | 20 | Spherical | 0.95 | 2.08 | 81 | 85 | 85 | 0.6 | 0.8 |
| Comparative | 80 | Spherical | 0.90 | 2.10 | 40 | 50 | 67 | 3.0 | 7.0 |
| Example1 | | | | | | | | | |
| Comparative | 100 | Spherical | 0.80 | 2.21 | 5 | 5 | 92 | 0.2 | 0.4 |
| Example 2 | | | | | | | | | |
| Comparative | 100 | Spherical | 0.80 | 2.21 | 8 | 8 | 92 | 0.2 | 0.4 |
| Example 3 | | | | | | | | | |
| Comparative | — | — | — | — | — | — | — | — | — |
| Example4 | | | | | | | | | |

### INDUSTRIAL APPLICABILITY

### Applicability of the Invention

According to the method of manufacturing opaque quartz glass of the present invention, it is possible to manufacture a large sized opaque quartz glass ingot having excellent heat ray shielding property and light blocking property and further resulted opaque quartz glass can be applicable as parts of semiconductor manufacturing apparatus and optical devices or the like.

1. A method for manufacturing an opaque quartz glass including melting granulated silica powder in which silica powder is dispersed in water at 45 to 75 wt % is spray-dried and granulated by wet pulverization controlling the average particle size of 8 μm or less and the standard deviation of the particle size to 6 μm or more, and melting the obtained granulated powder.

2. The method for manufacturing opaque quartz glass according to claim 1, wherein the BET specific surface area of the solids contained in the slurry after wet pulverization is set to 2 m²/g or more, and the slurry is spray-dried to form granulated substantially spherical silica particles.

3. The method for manufacturing opaque quartz glass according to claim 2, wherein the wet pulverization of silica powder is conducted using one or more beads selected from quartz glass beads, zirconia beads, silicon carbide beads.

4. The method for manufacturing opaque quartz glass according to claim 3, wherein the wet pulverization of silica powder is conducted using beads mill pulverization and one or more beads selected from ball mill pulverization, vibration pulverization, or at lighter pulverization.

5. The method for manufacturing opaque quartz glass according to claim 1, wherein heating is conducted by oxi-hydro flame heating.

6. The method for manufacturing opaque quartz glass according to claim 1, wherein the heating is conducted under vacuum atmosphere.
